(19) United States
(12) Patent Application Publication
(10) Pub. No.: US 2011/0098383 A1
(43) Pub. Date: Apr. 28, 2011

(54) Composite comprising nanosize powder and use of the composite

(75) Inventors: Wilfried Albert, Gross Ostheim (DE); Mario Brockschmidt, Essen (DE); Peter Gröppel, Erlangen (DE); Vicky Jablonski, Erlangen (DE); Gerhard Piecha, Nurnberg (DE); Uwe Schönamsgruber, Nurnberg (DE); Matthias Übler, Ursensollen (DE)

(73) Assignee: SIEMENS AKTIEGESELLSCHAFT, Munich (DE)

(21) Appl. No.: 12/737,336

(22) PCT Filed: May 29, 2009
(86) PCT No.: PCT/EP2009/056612

§ 371 Date: Dec. 30, 2010

(30) Foreign Application Priority Data
Jun. 30, 2008 (DE) 10 2008 030 904.4

(51) Int. Cl. C08L 63/00

(52) U.S. Cl. 523/457; 523/400

(57) ABSTRACT

A composite is formed from at least one base material and at least one filler powder mixture dispersed in the base material. The filler powder mixture has a filler powder fraction and at least one further filler powder fraction. The filler powder fraction has an average powder particle diameter (D50) selected from the range from 1 μm to 100 μm and the total proportion of the filler powder mixture in the composite (degree of fill) is above 50% by weight. The further filler powder fraction has a further average powder particle diameter selected from the range from 1 nm to 50 nm and the proportion of the further filler powder fraction in the filler powder mixture is selected from the range from 0.1% by weight to 50% by weight. A high degree of fill can be achieved at a low viscosity in the presence of nanosize filler particles. The composite is particularly suitable as embedding composition (pourable resin system).

### CROSS REFERENCE TO RELATED APPLICATIONS

This application is based on and hereby claims priority to International Application No. PCT/EP2009/056612 filed on May 29, 2009 and German Application No. 10 2008 030 904.4 filed on Jun. 30, 2008, the contents of which are hereby incorporated by reference.

### BACKGROUND

The invention relates to a composite comprising at least one base material and at least one filler powder mixture dispersed in the base material.

The composite is for instance a duroplast pourable resin system, such as is used in electrical engineering to produce high quality composite materials (e.g. insulating and construction materials). With the aid of the filler of the pourable resin system, electrical, mechanical and thermal properties of the resulting composite material are set. Such properties are for instance the thermal conductivity, the linear thermal expansion coefficient, the E-module or the fracture toughness of the composite material. Similarly, the reaction enthalpy which becomes free during the hardening process of the composite can be controlled.

Some of these properties depend on the degree of the fill level and thus on the size of the surface to be cross-linked, which is introduced into the composite by the filler.

In composite materials in the form of filled polymer materials with microscalar fillers (fillers with an average particle diameter in the μm range), the volume effect dominates in the influence on the properties of the composite material. This relates in particular to the electrical properties. Boundary surface effects, in other words effects which occur on account of the boundary surface between the base material of the composite and/or of the composite material and the filler, only play a minor role.

Some surprising property changes are found in the situation in which boundary surface effects obtain an increasing significance in comparison with the volume effects. This is then the case if fine filler powders are used with a large specific powder surface.

In order to vary the properties of a composite and thus of the composite material to a wide degree, attempts are thus made to use fine filler particles in addition to a high volume proportion. However, in the case of filled composite materials in the form of pourable resin systems, the viscosity noticeably increases as a result of the use of fine filler powders in comparison with pourable resin system with coarse, monomodal filler powders with approximately the same volume proportion of the filler. Pourable resin systems are however problematical since systems of this type are to be free-flowing at any point during production and processing. This means that the pourable resin systems are to be low-viscosity such that the system flows without the application of pressure.

The described increase in the viscosity can be achieved by increasing a processing temperature of the pourable resin systems or by using additives, which increase the flowability of the pourable resin systems. Both solutions involve an unwanted restriction in the processability (e.g. of a process window) of the pourable resin system and an increase in price of its processing processes. Similarly, a reduction in the degree of fill would counteract the increase in viscosity by using fine filler particles. This is however undesirable in respect of the widest possible variation in properties of the resulting composite material.

The publication WO 03/072646 A describes a highly filled but nevertheless flowable composite, which is formed of a pourable resin system filled with a filler. The base material of the pourable resin system is for instance a pourable resin based on epoxy in the form of a mixture of resin and hardening agent. The filler is a filler powder mixture made of fine, medium-coarse and coarse filler powder fractions. The fine filler powder fraction is composed of powder particles with an average powder particle diameter from the range of 1 μm to 10 μm. The average powder particle diameter of the medium-coarse and the coarse powder particle fractions are selected from the range of 10 μm to 100 μm and from the range of 100 μm to 1000 μm.

The use of several intentionally matched filler fractions with different particle size dispersions (filler powder mixture with multimodal particle size dispersion) enables the degree of fill to be increased by approximately 10% by weight and to a minor degree also a proportion of the fine filler powder fraction to be increased while retaining the viscosity level of the casting compound.

Precise compliance with the optimized quantity ratios of the filler fractions with different particle size dispersions is however also needed herefor. In practice, such precise mixture ratios with powdery additives can only be realized with difficulty and significant technical effort on account of their different sedimentation behaviors and different conveying characteristics.

### SUMMARY

One potential object is therefore to specify a composite, with which a high filler content is possible and at the same time a viscosity of the composite remains low with less effort compared with the related art.

To achieve the object, a composite is specified, comprising at least a base material and at least a filler powder mixture dispersed in the base material, with the filler powder mixture comprising a filler powder fraction and at least one further filler powder fraction, the filler powder fraction comprising an average powder particle diameter selected from the range of 1 μm to 100 μm and a total proportion of the filler powder mixture in the composite (degree of fill) is above 50% by weight. The composite is characterized by the further filler powder fraction having a further average powder particle diameter selected from the range of 1 mm to 100 nm and a proportion of the further filler powder fraction in the filler powder mixture being selected from the range from 0.1% by weight to 50% by weight.

The composite is a particle composite made from base material and filler. The base material represents a matrix, in which the filler and/or the filler particle of the filler powder mixture are dispersed. A homogenous dispersion of the filler particles preferably takes place in the base material.

The filler powder mixture has a multimodal particle size dispersion. At least one of the filler powder fractions comprises nanoscale filler particles. The average powder particle diameter (D₅₀) of this filler particle fraction is selected from the range of 1 nm to 100 nm and preferably from the range of 1 nm to 50 nm.

It has surprisingly been shown that, contrary to the knowledge from the related art, a high degree of fill and at the same time a low viscosity can currently be achieved by nanoscale filler particles. This may be attributed back to the very strong surface influence in the case of particles with a particle diameter in the nanometer range. An influence of volume-dependent properties takes a backseat with filler particles of this type.

As a function of the proportion of the nanoscale further filler powder fraction, the viscosity of the composite can be set in a wide range. According to a particular embodiment, the proportion of the further filler powder fraction in the filler powder mixture is selected from the range of 0.4% by weight to 40% by weight and in particular from the range of 0.5% by weight to 20% by weight. The proportion of the further filler powder fraction in the filler powder mixture and the total proportion of the filler powder mixture in the composite are preferably selected such that the further filler powder fraction with a proportion of a maximum 10% by weight and in particular with a proportion from the range of 0.1% by weight to 5% by weight is contained in the composite.

Particularly good results can then be achieved if the further average powder particle diameter is selected from the range of 5 nm to 30 nm. For instance, the average powder particle diameter amounts to 20 nm. The desired low viscosity is achieved when using powder particles with an average powder particle diameter from this range.

### DETAILED DESCRIPTION OF THE PREFERRED EMBODIMENT

Reference will now be made in detail to the preferred embodiments of the present invention, examples of which are illustrated in the following description.

According to a particular embodiment, the total proportion of the filler powder mixture in the composite is selected from the range of 60% by weight to 80% by weight. A higher total proportion of the filler material of for example 90% by weight or 95% by weight are likewise conceivable. As a result of the total proportion of the filler of this type, the properties of the composite and of the composite material obtained from the composite can be set to a very wide range. As a result of the presence of the nanoscale further filler, the processability of the composite nevertheless persists. The composite is therefore particularly suitable as a casting compound for use in a casting method. The composite can similarly be used very effectively in pressure gelling technology.

The individual filler powder fractions may be multimodal. This means that they can in turn be composed of several fractions with different particle size dispersions. For instance, the filler powder fraction or the further filler powder fraction is bi or trimodal.

The filler powder fractions can be formed of the same or different materials. According to a particular embodiment, the filler powder fractions therefore comprise powder particles with the same or with a different chemical composition. It is therefore conceivable to add nanoscale silica dust or fused silica (SiO₂) solely in order to set the viscosity of the composite. The electrical properties of the resulting composite material are set by the microscalar filler powder fraction. For instance, the microscalar filler is a barium titanate or a lead zirconate titanate (PZT). It is also conceivable for at least one of the filler powder fractions to be a mixture of powder particles with different chemical compositions. The microscalar filler powder fraction may therefore be a mixture of powder particles with chemical compositions of the barium calcium strontium titanate system (Baₓ, Ca_{y} Sr_{1-x-y} TiO₃), The nanoscale further filler powder fraction could be a mixture of powder particles made of silicon dioxide and aluminum oxide (Al₂O₃). Aluminum oxihydrate (AlO(OH)) is likewise conceivable as a material of the nanoscale further filler powder fraction. The cited materials could incidentally also be used for the microscalar filler powder fraction.

In particular, the chemical composition of the powder particles is selected from the group comprising metal carbonate, metal carbide, metal nitride, metal oxide and metal sulfide. Here mixtures of the cited compounds are conceivable. Metal carbonates, for instance dolomite (CaCO₃), can be used to reduce the combustibility of the resulting composite material.

Al₂0₂, Ti0₂, Fe₂0₃, Fe₃0₄, Ce0₂ or Zr0₂ are particularly suited to optimizing the different thermal properties. The nitrides A1N, BN, B₃N₄ or Si₃N₄ are suited to increasing a hardness of the resulting composite material. An improvement in the thermal conductivity is achieved with the carbides B₄C, TiC, WC, SiC and with boron nitride (BN).

The compounds used can, as shown in the examples, only comprise an anionic component in each instance. Similarly, mixture compounds can be used, which comprise several anionic components. A mixture compound of this type is for instance a metal oxysulfide.

The metal oxides can comprise a single type of metal. In one particular embodiment, the metal oxide comprises a mixed oxide with at least two different metals. A mixed oxide of this type is for instance lead zirconate titanate, with the aid of which the electrical properties of the composite and thus of the resulting composite material can be set in a further range. Materials of the already cited barium calcium strontium titanate system are also suited to setting the electrical properties of the composite material.

Finally, mineral nutrients are also considered as materials for the filler powder fractions. Materials of this type are for instance mica and slate flour. These materials are used inter alia to reduce the combustibility of the composite material.

In a preferred embodiment, filler particles of the filler powder fraction and/or filler particles of the further filler powder fraction have a spherical, splintered, flaky and/or short-phase particle form from the group. It has become evident that the spherical particle forms in particular exert a favorable influence on the viscosity of the composite.

The filler powder fractions can contain filler particles with a core shell structure. Such particles are characterized by a radial gradient in respect of their composition.

The used filler powder fractions can comprise uncoated filler particles. According to a further embodiment, filler particles of the filler particle fraction and/or filler particles of the further filler particle fraction comprise a particle coating. The filler particles are coated. The coating may be organic or inorganic. The coating can be applied to the particle surfaces of the powder particle using a coating method.

The base material may be inorganic in quality. In particular, the base material is an organic material. The organic material is a cross-linkable or an at least partially cross-linked polymer base material. As a result of a cross-linking reaction (curing) of the base material, the composite material (filled polymer material) results from the composite. A basic cross-linking reaction may be a polymerization, polyaddition or polycondensation. The cross-linking reaction can be initiated chemically, for instance anionically or cationically. Similarly, a cross-linking reaction induced by light or by the supply of heat is also possible.

According to a further aspect, the composite is used as a casting compound. The casting compound is used in a vacuum casting method for instance.

The casting compound comprises a liquid base material. The liquid base material may be formed of, for instance, diepoxide or polyepoxide compounds, hardening compounds based on amino acid anhydride or isocyanate and an acceleration component for an anionic or cationic reaction initiation. Similarly, further additives can be contained, for instance antifoaming agents, cross-networking aids, flexibilisators and suchlike.

The nanoscale further filler powder fraction can be used with the aid of a liquid. The use of a so-called suspension batch mixture is particularly suitable. Here the nanoscale further filler powder fraction is suspended in one of the liquid components of the composite, for instance in the epoxy resin, in the hardening component or in the flexibilisator.

The composite can also be used in the automatic pressure gelling technology. As a result of the adjustability of the viscosity of the composite, it is also particularly suited to this technology.

According to a further use, the composite is used as a molding compound. The composite is first molded into a desired shape by applying a pressure into a desired form and then hardened. The viscosity of the composite which is suited to filling an injection molding tool or die tool or to the injection molding and/or molding process can be set With the aid of the nanoscale further filler powder fraction.

In particular, the composite, as described above, is used to produce a composite material, preferably to produce a filled polymer material. The polymer material comprises the base material of the composite in the hardened form. In this polymer material, the filler powder mixture is dispersed.

According to a particular embodiment, the composite material is used as a construction material (structure material). The construction material is produced on the basis of the composite material. For instance, a housing or suchlike is produced from the composite material with the aid of the composite. To this end, the composite is processed and then hardened in a molding process, for instance by casting. The housing with the composite material results.

The inventors' proposals are advantageous as follows:
A composite is accessible, which allows for a high degree of fill. The presence of the nanoscale powder particles of the further filler powder ensures the processability as a result of a low viscosity of the composite material.
The composite can be identified by very good rheological properties, and is therefore particularly suited to use as a casting compound.
On account of the possibly high fill content, the properties of the composite and thus the properties of the composite material produced from the composite can be set in a wide range.

The proposals are described in more detail below with the aid of several examples. Table 1 contains a summary of the basic materials used with their properties. These include the average particle diameter and the specific surface.

The filler types A, B and C are used as a microscalar filler powder fraction. The filler type D may be used as a nanoscale further filler powder fraction. All filler types are formed of SiO₂. Silbond® includes silica dust products from Quartzwerke Frechen.

| | | Particle | Special | Surface |
|---|---|---|---|---|
| | | diameter | surface | per kg |
| Type | Filler name | (D₅₀) [μm] | [m²/g] | filler [m²] |
| A | Silbond W 6 ® | 31 | 0.5 | 500 |
| B | Silbond W 12 ® | 20.2 | 0.9 | 900 |
| C | Silbond W 800 ® | 2.53 | 4.5 | 4500 |
| D | Nanosize filler | 0.02 | 90 | 90000 |

Table 2 contains filler powder mixtures (Types E to I) produced from the filler powder types A to D. Type E in this table represents a comparison powder mixture outside the scope of the inventors' proposal, which only has microscalar filler powder fractions.

TABLE 2

| | | Type mixture ratio | Surface per kg |
|---|---|---|---|
| Type | Filler type | [% by weight] | total filler [m²] |
| E | A/C | 87:13 | 1025 |
| F | B/D | 99.15:0.85 | 1654 |
| G | B/D | 98.32:1.68 | 2394 |
| H | B/D | 96.63:3.37 | 3878 |
| I | B/D | 94.95:5.05 | 5411 |

Epoxide-based composites were produced from the filler powder mixtures. Table 3 contains the viscosity values of the composites as a function of the degree of fill.

TABLE 3

| | | Total | | | | |
|---|---|---|---|---|---|---|
| | | proportion | | Viscosity [mPa * s] | | |
| | | of the | Surface per kg | T = 50° C.) with | | |
| Ex- | | filler [% | casting | shearing rates in 1 s⁻¹ | | |
| ample | Type | by weight | compound [m²] | 0.1 | 1 | 10 |
| 1 | A | 64 | 320 | 2500 | 3500 | 5000 |
| 2 | B | 64 | 576 | 6000 | 12000 | 11000 |
| 3 | C | 64 | 2880 | 12000 | 12500 | 28000 |
| 4 | D | 40 | 36000 | 14000 | 15000 | 12500 |
| 5 | E | 64 | 656 | 5200 | 4800 | 4400 |
| 6 | E | 72 | 738 | 12000 | 18000 | 18000 |
| 7 | F | 64 | 1059 | 6277 | 8945 | 6936 |
| 8 | G | 64 | 1532 | 7035 | 8714 | 6557 |
| 9 | H | 64 | 2482 | 6260 | 6869 | 5321 |
| 10 | F | 67.33 | 1114 | 14154 | 20550 | 13660 |
| 11 | F | 70.91 | 1173 | 51633 | 54369 | 30000 |
| 12 | G | 67.33 | 1612 | 15727 | 18268 | 12032 |
| 13 | G | 70.91 | 1698 | 51313 | 46253 | 25929 |
| 14 | H | 67.33 | 2611 | 15063 | 14067 | 9498 |
| 15 | H | 70.91 | 2750 | 39075 | 29250 | 17543 |
| 16 | I | 67.33 | 3643 | 12448 | 10772 | 7830 |
| 17 | I | 70.91 | 3837 | 33014 | 22395 | 14417 |

With use of filler powder mixtures having a microscalar filler powder fraction and a nanoscale further filler powder fraction, high viscosity values are achieved with a high total proportion of filler (in particular examples 11, 13 and 15), which nevertheless reduce with an increasing proportion of nanosize particles (Example 17).

Table 4 contains examples of an epoxide casting system hardened by acid anhydrides as a function of the degree of fill and the particle size dispersion. Both the viscosity of the respective composites (base materials) and also the form properties of the resulting composite (fracture toughness, specific fracture energy and bending strength) are listed.

TABLE 4

| | | | Viscosity | | | |
|---|---|---|---|---|---|---|
| | | Proportion of filler | [mPa * s] | | Specific | |
| | | in the casting | (T = 50° C., | Fracture | fracture | Bending |
| | Filler | compound [% by | shearing | toughness | energy | strength |
| Example | type | weight] | rate 1) | [mPa * m^{0.5}] | [J/m²] | [N/mm²] |
| 18 | B | 66 | 12000 | 1.9 | 340 | 120 ± 11 |
| 19 | E | 66 | 6500 | 2.0 | 350 | 111 ± 4 |
| 20 | E | 74 | 22000*⁾ | 2.3 | 370 | 122 ± 5 |
| 21 | F | 66 | 10407 | 1.95 | 350 | 119 ± 8 |
| 22 | G | 66 | 9057 | 2.05 | 385 | 121 ± 4 |
| 23 | H | 66 | 6534 | 2.15 | 410 | 124 ± 7 |
| 24 | G | 70 | 23822 | 2.2 | 390 | 126 ± 9 |
| 25 | I | 70 | 12109 | 2.2 | 379 | 125 ± 9 |
| 26 | I | 71 | 14600**⁾ | 2.3 | 400 | 130 ± 10 |

*⁾measured at 70° C.
**⁾measured at 60° C.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A composite comprising:
at least one base material; and
a filler powder mixture dispersed in the base material such that the composite contains more than 50% by weight of the filler powder mixture, the filler powder mixture being formed from at least first and second filler powder fractions, wherein
the first filler powder fraction has an average powder particle diameter of from 1 μm to 100 μm,
the second filler powder fraction has an average powder particle diameter of from 1 nm to 100 nm, and
the filler powder mixture contains from 0.1% by weight to 50% by weight of the second filler powder fraction.

17. The composite material as claimed in claim 16, wherein the filler powder mixture contains from 0.1% by weight to 20% by weight of the second filler powder fraction.

18. The composite material as claimed in claim 16, wherein the filler powder mixture contains from 0.2% by weight to 10% by weight of the second filler powder fraction.

19. The composite material as claimed in claim 16, wherein the second filler powder fraction has an average powder particle diameter of from 5 nm to 100 nm.

20. The composite material as claimed in claim 16, wherein the composite contains from 60% by weight to 80% by weight of the filler powder mixture.

21. The composite material as claimed in claim 16, wherein at least one of the filler powder fractions is monomodal.

22. The composite material as claimed in claim 16, wherein the filler powder fractions are formed from powder particles having the same chemical composition.

23. The composite material as claimed in claim 16, wherein the filler powder fractions are respectively formed from powder particles having different chemical compositions.

24. The composite material as claimed in claim 16, wherein the filler powder fractions are formed from powder particles having the same or different chemical composition(s), and
the filler powder fractions are formed from at least one type of powder particles selected from the group comprising of metal carbonate, metal carbide, metal nitride, metal oxide and metal sulfide powder particles.

25. The composite material as claimed in claim 24, wherein at least one of the filler powder fractions is a mixture formed from oxides of at least two different metals.

26. The composite material as claimed in claim 16, wherein the base material is formed from a cross-linkable or at least partially cross-linked polymer base material.

27. The composite material as claimed in claim 16, wherein at least one of the filler powder fractions contains filler particles having a particle form selected from the group consisting of spherical, splintered, plate-shaped and short-phase particle forms.

28. The composite material as claimed in claim 16, wherein at least one of the filler powder fractions contains coated particles.

29. The composite material as claimed in claim 16, wherein the base material is a casting compound base material.

30. The composite material as claimed in claim 16, wherein the base material is a molding compound.

31. A construction material comprising:
an epoxy base material; and
a filler powder mixture dispersed in the base material such that the composite contains more than 50% by weight of the filler powder mixture, the filler powder mixture being formed from at least first and second filler powder fractions, wherein
the first filler powder fraction has an average powder particle diameter of from 1 μm to 100 μm, the first filler powder fraction being formed from silica dust,
the second filler powder fraction has an average powder particle diameter of from 1 nm to 100 nm, the second filler powder fraction being formed from silicon dioxide, and
the filler powder mixture contains from 0.1% by weight to 50% by weight of the second filler powder fraction.

32. The construction material as claimed in claim 31, wherein the second filler powder fraction is formed from a mixture of silicon dioxide and aluminum oxide.

33. The construction as claimed in claim 31, wherein the construction material is a molded product, which has been molded into a desired shape and then hardened with an epoxy hardener.
